(19) United States
(12) Patent Application Publication
(10) Pub. No.: US 2026/0303008 A1
(43) Pub. Date: Oct. 1, 2026

(54) DOUBLE-LAYER PHOTOVOLTAIC INSTALLATION

(71) Applicant: ADAPTIVE AND MULTIFUNCTIONAL PHOTOVOLTAIC SYSTEMS S.R.I., Reggio Calabria (IT)

(72) Inventors: Cosimo BORRELLO, Reggio Calabria (IT); Rosario CARBONE, Reggio Calabria (IT)

(73) Assignee: ADAPTIVE AND MULTIFUNCTIONAL PHOTOVOLTAIC SYSTEMS S.R.I., Reggio Calabria (IT)

(21) Appl. No.: 19/489,027

(22) PCT Filed: May 29, 2024
(86) PCT No.: PCT/IB2024/055196

§ 371 Date: Dec. 1, 2025

(30) Foreign Application Priority Data
Jun. 9, 2023 (IT) 102023000011895

(51) Int. Cl. H02S 20/32; H02S 40/22

(52) U.S. Cl. CPC H02S 20/32; H02S 40/22

(57) ABSTRACT

A double-layer photovoltaic installation, comprising a top layer and a bottom layer, wherein: —the top layer of the installation consists of a plurality of bifacial photovoltaic strings (A) arranged parallel to one another and each of which has a top surface (Fs) and a bottom surface (Fi), both capable of generating electric energy from the sun; —a single axis solar tracking system is connected to the photovoltaic strings (A), the former being adapted to rotate the latter by an angle (α) around their rotation axes (5); —the solar tracking system orients the photovoltaic strings (A) arranging the top surface (Fs) and the bottom surface (Fi), of each photovoltaic string (A), in a position parallel to the incident sunbeams, so that only a minimum shadow is projected on the bottom layer of the installation; —the bottom layer of the installation consists of further photovoltaic strings or of reflecting surfaces.

### CROSS-REFERENCE TO RELATED APPLICATIONS

This Patent Application claims priority from Italian Patent Application No. 102023000011895 filed on Jun. 9, 2023, the entire disclosure of which is incorporated herein by reference.

### TECHNICAL FIELD OF THE INVENTION

The present invention relates to a photovoltaic installation for generating electric energy by means of conversion of sunlight, in which, in order to optimize the overall exploitation of the sunlight incident on the installation, it is proposed to utilize a double layer of photovoltaic strings, a top one and a bottom one. Furthermore, a single axis tracking system of the position of the sun controls the photovoltaic strings of the top layer according to a completely new logic, with respect to the prior art. Therefore, the invention falls within the category of the so-called photovoltaic generators equipped with a solar tracker of the single axis type.

### PRIOR ART

It is known that a photovoltaic cell (a specially provided foil made of semiconducting material, the most common of which is silicon) when exposed to sunlight is capable of converting it into electric energy, in direct current. The conversion efficiency of a photovoltaic cell is usually obtained by evaluating the ratio of the electric energy generated by the cell to the luminous energy captured by the photovoltaic cell, using the entire surface thereof exposed to the sun. To date, due to various phenomena, the conversion efficiency of the photovoltaic cells is still very low. The latest generation photovoltaic cells already commercialized are characterized by maximum efficiencies of just over 20%, whereas photovoltaic cells showing maximum efficiencies of around 30% are still being studied. In order to go beyond such values and reach the very recent record values of approximately 46%, it is necessary to resort to special “multi-junction” photovoltaic cells, in combination with just as special (and bulky and expensive) sunlight optical concentrators.

It is also known that the conversion efficiency of the photovoltaic cells, results to be very sensible to the angle of incidence with which the light hits the surface thereof exposed to the sun. The maximum efficiency is obtained when the sunbeams are perpendicularly incident on their surface. For this reason, specially provided systems have been designed and manufactured, called “solar trackers”, thanks to which it is possible to constantly detect and track the position of the sun so as to be able to constantly orient the photovoltaic cells in the position of maximum generation of electric energy. The most sophisticated trackers are those equipped with two degrees of freedom (controlling both the azimuth angle and the tilt angle) and, thanks to their use, the electric energy annually generated by a photovoltaic installation can be increased up to 40% with respect to that obtained with “fixed” photovoltaic installations, the photovoltaic cells exposed to the sun and the environmental and atmospheric conditions being equal. However, the manufacturing and operating costs, in addition also to the high unavailability rate of said complex systems, suggest the alternative use of less complex tracking systems with one single degree of freedom; these are the so-called single axis solar trackers. Their lower complexity significantly reduces their manufacturing and operating costs and also makes them more reliable. The increase in electric energy annually generated by using single axis solar tracking systems of the “polar axis” type (with rotation axis parallel to the north-south terrestrial direction) can also be of 30% with respect to that obtained with “fixed” installations, the photovoltaic cells exposed to the sun and the environmental and atmospheric conditions being equal. Such percentage of increase in the electric energy annually generated is however bound to decrease should the direction of the rotation axis be different from the north-south one. In any case, also with the use of the single axis solar trackers, various problems remain that are linked to the manufacturing costs and to the operating stops of the consequent photovoltaic installations based on these systems. Among the most significant problems, the following are to be certainly mentioned: (i) the costs of the additional components intended for the rotating supports of the photovoltaic modules and of the components specifically dedicated to their command and control; (ii) the energy consumption of the solar tracking actuation servo-mechanisms (up to 5% of that generated); (iii) the decrease in the reliability and in the availability of the photovoltaic generator, consequent to the greater complexity of the installation and to its direct exposure (comprising the components of the solar tracking system) to aggressive atmospheric agents (mainly wind and corrosive atmospheres).

Furthermore, the photovoltaic installations which provide for the use of solar tracking systems, also only single axis solar tracking systems, pose an additional and important problem which is that of the high terrestrial land occupation. In fact, in order for the solar tracking to be able to give its maximum benefits, in terms of increase in the generation of electric energy, it is strictly necessary for the photovoltaic strings installed in side-by-side rows, on the specially provided trackers, not to mutually shadow one another, not even partially, throughout the day and during the rotations. When the installation is formed by a multitude of photovoltaic strings, the latter problem makes it necessary to install the photovoltaic strings in side-by-side parallel rows significantly spaced apart from one another. Consequently, the terrestrial surface usefully exposed to the sun and occupied being equal, in a photovoltaic installation equipped with a single axis solar tracking system, manufactured according to the prior art (with “perpendicular” tracking), the photovoltaic power installed per unit of surface results to be significantly lower than a “fixed” installation, in which, the above-mentioned phenomena of mutual shadowing among the strings not being manifested, said strings can be installed very close to one another. The result of what just specified is that the increase in energy which can be produced by the photovoltaic installations equipped with single axis solar trackers hardly manages to compensate the reduction in the photovoltaic power which can be installed per unit of occupied terrestrial surface. In other words, the final result is that the electric energy generated by a photovoltaic installation equipped with a single axis solar tracker occupying a certain surface results to be approximately equal to that which can be generated by a fixed installation occupying (with a greater quantity of photovoltaic cells) the same surface.

All of the above is, to a large extent, a consequence of the fact that, still to date, the conventional solar tracking systems (also those of single axis type) are conceived as equipped with special “additional” movable support systems, on which to install totally conventional photovoltaic modules usually used also in the fixed installations. Furthermore, the conventional solar tracking systems are still conceived and constructed for ground installations or installations on flat roofs, thus following logics of full exposure to the landscape and, especially, to adverse atmospheric agents. Finally (but not for this reason the aspect is to be considered less important), all solar trackers (also the single axis ones) are conceived starting from the basic idea of implementing a solar tracking, the main aim of which is to orient the surface of the photovoltaic strings exposed to the sun always and as much as possible perpendicular to the incident sunbeams, so as to maximize the direct generation of electric energy.

Ultimately, proceeding according to the prior art, the obtained photovoltaic installations are very bulky, expensive, not very reliable and with a strong environmental impact, especially in terms of large terrestrial land occupation and, therefore, of low photovoltaic power which can be installed per unit of occupied terrestrial surface.

The need was thus felt for a photovoltaic installation having technical characteristics capable of overcoming the abovementioned drawbacks of the prior art.

### DESCRIPTION OF THE INVENTION

The object of the present invention is a double-layer photovoltaic installation, the essential technical characteristics of which are described in the independent claim 1 and the secondary or auxiliary technical characteristics of which are described in claims 2-7.

A further object of the present invention is a method for producing electric energy from a photovoltaic installation, the essential technical characteristics of which are described in the independent claim 8 and the secondary or auxiliary technical characteristics of which are described in claim 9.

Unlike the single axis solar tracking photovoltaic installations of the prior art, the photovoltaic installation according to the present invention originates with the primary intent of significantly increasing the useful exploitation of the sunlight incident on a fixed terrestrial surface and this by fundamentally following two new routes.

The first route consists in manufacturing the photovoltaic installations by occupying the available terrestrial surface with two superimposed layers of photovoltaic strings (in actual fact, a first layer above a second layer below it).

The second route consists in equipping the upper (or top) layer of photovoltaic strings with a single axis solar tracking system, constitutively totally similar to those of the prior art but which is controlled according to a totally new logic of orientation of the photovoltaic strings with respect to the sunbeams incident on them.

As is better specified in the following, the single axis solar tracking system with which the photovoltaic strings of the top layer are equipped provides for orienting them so that they result to be parallel to the sunbeams incident on them, instead of perpendicular as in the solutions of the prior art.

According to the principle just stated, the sunlight incident on the photovoltaic strings of the top layer, by lapping the surfaces of the same, passes through them almost entirely, thereby being able to be incident on the surfaces of the photovoltaic strings of the lower (or bottom) layer. The latter are designed to capture the sunlight coming from the photovoltaic strings of the top layer according to the prior art. Namely, they can be designed and constructed in different manners but, anyway, according to techniques and technologies already known and already utilized. For example, the photovoltaic strings of the bottom layer can be bifacial and equipped with a single axis solar tracking system (distinct from and independent of that of the photovoltaic strings of the top layer) but can also be monofacial and fixed and completely opaque or semi-transparent.

In order to contain the installation costs, but always with the objective to elevate the electric energy which can be generated per unit of occupied terrestrial surface, the photovoltaic strings of the bottom layer can also be replaced with simple reflecting surfaces.

Ultimately, the photovoltaic installation according to the present invention pursues the objective to convert the incident sunlight into electric energy by exploiting two superimposed layers of photovoltaic strings. The first layer of photovoltaic strings is only lapped by the sunlight (which, therefore, passes through it) and converts only the diffused and reflected components thereof into electric energy. The second lower layer, instead, converts the sunlight coming from the top layer according to the prior art and, simultaneously, reflects it again towards the upper photovoltaic strings.

The expectation, however already experimented, is to obtain a significant increase, with respect to the prior art, both in the photovoltaic power which can be installed and in the generated electric energy, for a fixed occupied terrestrial surface.

Furthermore, even if the bottom layer of the installation is equipped with a single axis solar tracking system, distinct from and independent of that of the photovoltaic strings of the top layer, if considered profitable, it is possible to control the degree of transparency of the installation to the incident sunbeams. According to this method, the installation assumes, in actual fact, a double functionality, it being possible to adjust, simultaneously and in an optimal manner, both the production of electric energy and the quantity of natural light with which to illuminate the environments below.

### BRIEF DESCRIPTION OF THE DRAWINGS

In the following, some embodiments are described by way of non-limiting example with the aid of the accompanying figures, wherein:

FIG. 1 illustrates the constitution of each one of the bifacial photovoltaic strings (A) which constitute the top layer of the installation;

FIG. 2 illustrates a plurality of bifacial photovoltaic strings (A) of the top layer, installed in side-by-side parallel rows;

FIG. 3 illustrates the photovoltaic installation in the case where the bifacial photovoltaic strings (B) which constitute the lower bottom layer of the installation, have the same constructive characteristics of the strings (A) of the top layer but which, with respect to the latter, can be different in number, can be installed according to different directions and can be led to rotate distinctly, with their own single axis solar tracking system, also with different logics of orientation with respect to the sun;

FIG. 4 illustrates the photovoltaic installation in the case where the bottom layer of the installation is composed of one single bifacial and semi-transparent photovoltaic string (C), without a solar tracking system and equipped with a flat surface, the area of which is equal to the overall flat surface identified by all the strings (A) of the top layer;

FIG. 5 illustrates the photovoltaic installation in the case where the bottom layer of the installation is composed of a monofacial and non-transparent photovoltaic string (D), without a solar tracking system and equipped with a flat surface, the area of which is equal to the overall flat surface identified by all the strings (A) of the top layer;

FIG. 6 illustrates the photovoltaic installation in the case where instead of photovoltaic strings, the bottom layer of the installation is composed of a reflecting surface (E), fixed and equipped with a surface which is also not flat, the ground footprint area of which though is equal to the overall flat surface identified by all the strings (A) of the top layer;

FIG. 7 illustrates a first applicative example (photovoltaic agricultural greenhouse) in which the photovoltaic installation is made inside a transparent casing which protects it from adverse atmospheric agents;

FIG. 8 illustrates a second applicative example (double-layer photovoltaic module) in which the transparent and protective casing of the photovoltaic strings is built ad hoc, so that it can also be integrated in general buildings/manufacturing products.

### BASIC COMPONENTS OF THE INSTALLATION ACCORDING TO THE INVENTION

Object of the invention is the construction of a double-layer photovoltaic installation of photovoltaic strings, a top one and a lower bottom one, in which the photovoltaic strings of the top layer are equipped with a solar tracking system of single axis type, constitutively very similar to those of the prior art but, unlike the latter, controlled according to a completely new solar tracking logic.

The main constituting elements of the photovoltaic installation according to the invention are:
the photovoltaic strings of the top layer, which are provided of “bifacial” type and necessarily equipped with a solar tracking system of single axis type;
the photovoltaic strings of the lower bottom layer, which can be both bifacial and monofacial and can be equipped with a single axis solar tracking system distinct from and independent of that of the strings of the top layer but which can also be of fixed type (i.e. without solar tracking system);
possible reflecting surfaces which, if present, replace the photovoltaic strings of the lower bottom layer and can have a surface which is also not flat;
a possible casing, equipped with a transparent cover, inside which, in particular cases, the entire photovoltaic installation can be manufactured according to the present invention.

The constructive characteristics and the peculiarities of said basic elements, as well as further possible accessory components, will be evident from the following detailed description of the invention, which is anticipated by a brief presentation and description of the figures and images, these too functional for the clear understanding of the constitution and operation of the photovoltaic installation according to the present invention.

### EMBODIMENTS OF THE INVENTION

The constitutive and operating peculiarities of the present photovoltaic installation are also specified by means of explicative drawings, shown in just as many figures which, in this section, are listed and only briefly described. Reference will be made to such figures in a more detailed manner also in the following paragraph.

Just as for the photovoltaic installations of the prior art, the fundamental element of the installation according to the present invention remains the photovoltaic cell, already summarily described in the introductory section. A congruous number of photovoltaic cells is thus utilized for forming, in primis, the so-called photovoltaic modules, obtained by physically and electrically connecting together in series a congruous number of the aforementioned photovoltaic cells. Subsequently, a congruous number of photovoltaic modules are assembled and connected together for forming the so-called photovoltaic strings and, finally, a congruous number of photovoltaic strings are placed side-by side for forming the so-called overall photovoltaic field (or generator).

Similar to what occurs in some specific fields of the prior art, and in particular in the field of the photovoltaic installations which provide for the use of the solar trackers or the use of modules and transparent or semi-transparent photovoltaic strings, the modules (and the consequent photovoltaic strings) utilized for the construction of the photovoltaic generator according to the present invention can be, in all or in part, of the bifacial type. It is understood that this term refers to the modules (and to the consequent photovoltaic strings), equipped with two faces (a top face and a bottom face) which both have the ability to convert the sunlight incident on them into electric energy. Said bifacial modules can be manufactured with different techniques and technologies; they can be manufactured with single bifacial cells (already in commerce), each one characterized “per se” by two (top and bottom) faces, typically with a different ability to convert the sunlight into electric energy. However, they can also be manufactured with identical conventional monofacial cells, to be installed distinctly on the two faces of the modules (the top one and the bottom one), so as to guarantee, for example, the same (but distinct) ability thereof to convert the sunlight into electric energy.

Still with regard to the photovoltaic modules, which assembled together give origin to the photovoltaic strings of the installation according to the present invention, they can be of commercial type (thus totally conventional) but, in some cases, they can also be custom designed and built, as is better specified in the following description of some applicative examples.

As already expressed in the title, the photovoltaic installation according to the present invention is provided to be composed of two distinct and independent layers of photovoltaic strings: the upper top layer and the lower bottom layer.

The photovoltaic strings of the top layer are necessarily equipped with a single axis solar tracking system. Constitutively, it is totally similar to the single axis solar trackers of the prior art. In particular, one or more electric motors and specially provided transmission systems intercept the rotation axes, with which the photovoltaic strings of the top layer are equipped and specially provided electronic control drivers impose on the motors axial rotations such to implement the desired logics of solar tracking by the photovoltaic strings.

Therefore, the first fundamental novelty and peculiarity of the photovoltaic installation according to the present invention, is to be searched exactly in the particular control logic of the orientation of the photovoltaic strings of the top layer with respect to the sunbeams incident on them. In fact, in a totally new manner, the solar tracking system is required to orient the photovoltaic strings of the top layer “parallel” to the sunbeams incident on them.

Even if this tracking logic, which for convenience we call “parallel tracking”, might seem counterproductive (from the point of view of the conversion efficiency of the sunlight into electric energy), we believe, instead, that, if correlated to the existence of the second bottom layer of photovoltaic strings, it can express new and very useful properties, to the point of managing to maximize, more than every different solution of the prior art, the exploitation of the sunlight incident on a fixed terrestrial surface to be occupied.

It is well known that the conversion efficiency of the incident sunlight into electric energy, by the photovoltaic cells, strongly depends on the angle with which the sunbeams are incident on the surfaces of the latter: the conversion efficiency is maximum if the sunbeams result to be perpendicular to the surface of the photovoltaic cell, whereas it tends to zero if the sunbeams result to be parallel to the same surface. That said, it results to be just as evident that the aforementioned “parallel tracking”, in principle, does not guarantee any form of “direct” conversion of the sunlight incident on the photovoltaic installation according to the present invention into electric energy. However, it is also true (and just as known) that the photovoltaic cells convert the sunlight into electric energy not only by intercepting the sunbeams which are directly incident on them but also by intercepting the sunlight present in the environment surrounding the installation of the photovoltaic cells which is indirectly incident on the surfaces of the same thanks to the known diffusion and/or reflection phenomena. This “indirect” sunlight strongly depends on the physical characteristics of the environment surrounding the installation of the photovoltaic cells; said phenomenology also leads back to the well-known concept of “albedo” of a certain physical environment.

Thanks to the latter phenomenology, it is easily understood that the photovoltaic strings of the top layer of the installation according to the present invention, although oriented parallel to the sunbeams incident on them, produce a certain quantity of electric energy by converting only the diffused and reflected sunlight captured by their two faces (top face and bottom face) and that such quantity of electric energy significantly depends on the albedo value of the installation physical environment surrounding the strings.

First of all, it is relevant to emphasize that the quantity of electric energy generated “indirectly” by the photovoltaic strings of the top layer, oriented parallel to the sunbeams incident on them, depends, in a very relevant manner, exactly on the quantity of incident sunbeams which, by passing through the photovoltaic strings, are incident on the environment below them, to then be reflected towards the top layer. The more intense the sunbeams managing to pass through the photovoltaic strings of the top layer, the greater the reflected light which, “bouncing” upwards, can go back to be incident on them, thereby increasing the quantity of electric energy generated, in an indirect manner, by the strings of the top layer.

It is thus clear that, in absolute opposite trend with respect to the solutions of the prior art (“perpendicular” tracking), the aim of the parallel tracking according to the present invention is to maximize, simultaneously and in the first instance, the transparency of the photovoltaic strings of the top layer to the sunbeams incident on them and the “indirect” production of electric energy, thanks to the maximization of the diffused sunlight and of the sunlight reflected by the bottom layer.

It is the case to emphasize that, the aim of the perpendicular tracking according to the prior art, on the contrary, is to maximize only the direct generation of the electric energy generated by the photovoltaic strings, whereas the indirect generation will inevitably remain reduced in a significant manner. In order to understand this, it is sufficient to consider that the photovoltaic strings oriented perpendicular to the sunbeams cause a strong shadowing (obscuration) of the physical environment below them, thereby reducing the component of reflected light.

In the installations according to the prior art, the remarkable reduction in the illumination of the physical environment below the photovoltaic strings, also has negative environmental effects; think of, for example, the agricultural sector: it is evident that the ground below such an installation may not be effectively utilized for cultivation. On the contrary, in the installations according to the present invention, the maximization of the lighting of the environment below can also have positive environmental effects, in terms of better profitable exploitation of the ground; these effects very much depend on the constructive and functional characteristics of the bottom layer of the installation.

In order to be able to match the expected energetic performance of the photovoltaic installation according to the present invention to one's expectations but also, and especially, to one's financial means, the photovoltaic strings of the bottom layer can be, in fact, of different type and can be designed and constructed referring to different techniques and technologies already available and known. For example, the energetic performance of the photovoltaic installation according to the present invention can be maximized, by designing and constructing the photovoltaic strings of the bottom layer as the strings of the top layer, even if in a totally distinct and independent manner. In this case, however, the achievement of the maximum energy yield would correspond to the maximum manufacturing cost of the installation and also the maximum complexity of the same. Less performing but also less expensive and complex solutions can be achieved by designing and constructing the strings of the bottom layer so that they result to be different from the strings of the top layer. For example, a certainly more cost-effective and simpler photovoltaic installation, but also less performing, can be achieved by utilizing as lower bottom layer the “fixed” (without solar tracker) monofacial photovoltaic strings or, even, by manufacturing the bottom layer with simple reflecting surfaces, instead of with additional photovoltaic strings.

Before going more in depth in the constructive details of the proposed photovoltaic installation, it is very important to emphasize a further aspect which characterizes the photovoltaic installation according to our invention and, more specifically, the solar tracking system with which the photovoltaic strings of the top layer must be necessarily equipped. In the photovoltaic installations of the prior art, in order to perfectly implement solar tracking logics of “perpendicular” type, it is strictly necessary for the tracking system to be of the dual axis type (and therefore very expensive, complex and not very reliable). If, in order to reduce the costs and the complexity and increase the reliability of the tracking system, one recurs to a single axis tracking system, the “perpendicular” tracking will inevitably result to be imperfect, with a consequent reduction in the conversion efficiency of the sunlight into electric energy. Furthermore, the latter significantly depends, besides on the tilt (fixed) angle with which the photovoltaic strings are installed, also on the (just as fixed) direction of their rotation axes, being the direction of maximum efficiency the polar one, i.e. the same of the terrestrial rotation axis. Unlike what just now specified, in order to achieve the proposed “perfect” parallel solar tracking, a simple single axis solar tracker is always sufficient. Furthermore, it can always be achieved (in a perfect manner), whatever the orientation direction of the rotation axis of the strings and whatever the tilt angle with which they are installed. In fact, it can be easily experimented that, for any direction of the rotation axes and for any value of the tilt angle of a string equipped with a single axis rotation system, it is always possible to find a rotation angle around the relative axis in correspondence of which the string is shown oriented parallel to the sunbeams incident on it, thereby causing only a very thin shadow projection on the environment below it.

A further and relevant effect of the parallel single axis solar tracking is that the photovoltaic strings can be side-by-side in parallel rows and will be able to carry out the aforementioned solar tracking, on a daily basis, without ever mutually shadowing one another, even if installed very close to one another. In this case, their inter-distance can be optimized so as to always prevent the mutual shadowing phenomena among the strings and the solution to such problem depends on the installation direction of the rotation axes of the side-by-side strings. In particular, the inter-distance which guarantees the absence of shadowing between the strings results to be minimum when their rotation axes are coincident with the east-west terrestrial direction, whereas it is maximum—but anyway small and equal to the width of one single string—if their rotation axes are oriented according to the north-south terrestrial direction. What specified above implies that, the ground footprint surface being equal, the parallel solar tracking, with respect to the perpendicular solar tracking of the prior art, (always) allows the installation of a potentially much greater number of side-by-side photovoltaic strings; which makes it a legitimate aim to be able to generate much more electric energy, per unit of terrestrial surface occupied by the installation.

Having described the principle behind the double-layer photovoltaic installation, in the following the constitution and the manufacturing procedure thereof is specified in detail.

The main photovoltaic strings, which constitute the top layer and which we also call “bifacial photovoltaic strings (A)”, are obviously of fundamental importance.

They typically have a rectangular or square shape; they have transversal edges (1) and longitudinal edges (2) which delimit a flat surface (S_{A}), which has width (a) and length (b) and the two faces of which, the top face (F_{S}) and the bottom face (F_{I}), can be manufactured also with different technologies and materials.

The strings (A) are also equipped with terminations (3), mounted on their transversal edges (2), and each termination (3) is equipped with a specially provided longitudinal pin (4). The aforementioned longitudinal pins (4) are manufactured in any point of the terminations (3) but, for each string (A), they have to result to be aligned longitudinally with respect to one another so as to form, in actual fact, a longitudinal rotation axis (5).

Thanks to the terminations (3) and to the relative pins (4) with which the strings (A) are equipped, a solar tracking system can mechanically intercept them for allowing them to perform a single axis rotation, also up to 180°.

The rotation axes (5) of the strings (A) are oriented along any direction.

The strings (A) are arranged in side-by-side parallel rows and the distance (d) between the relative rotation axes (5) is chosen as a function of the installation direction of the axes (5) and its maximum value (in the case where the axes are oriented along the north-south direction) is not much greater than the width (a) of one single string (A), for allowing a rotation, when necessary, also up to an angle equal to 180°.

In order to maximize the useful exploitation of the sunlight which, being incident on the strings (A) and which, consequently to the parallel tracking, passes through them, the photovoltaic installation according to the present invention must be completed by manufacturing a second layer below the top one just specified.

The aforementioned lower (or bottom) layer can be manufactured by using additional photovoltaic strings which can be identical to the strings (A) and have the same dimensional, constructive and orientation characteristics thereof. However, said additional strings of the bottom layer can also be different from the strings (A); for example, they may not be equipped with a solar tracking system and can also be bifacial but semi-transparent or monofacial and completely opaque to the incident sunlight.

In this manner, by integrating the presence of the strings (A) of the top layer with other additional photovoltaic strings placed under them, the overall (double-layer) photovoltaic installation can assume different conformations and achieve different combined levels of electricity generation and natural lighting of the surface below the overall installation, being the terrestrial surface exposed to the sun fixed and occupied as a whole.

In order to contain the manufacturing costs of the photovoltaic installation, while still maintaining significant its ability to generate electricity, instead of being manufactured with additional photovoltaic strings, the bottom layer can be manufactured with simple reflecting surfaces (E), also not flat and which can be both fixed and equipped with a single axis solar tracking system independent of that of the photovoltaic strings (A).

Whereas, should the sunlight also have per se an important additional value (as it could be, for example, in the case of photovoltaic installations manufactured on agricultural grounds), then the double-layer installation could be manufactured, in constitutive and functional terms, so that, besides producing a generation of electric energy of all respect, it lets a certain (controllable) quantity of natural light pass also under it and towards the ground below it.

In particular cases, also of great practical relevance, the photovoltaic installation according to the present invention can be conveniently manufactured, in its totality, inside a specially provided protective casing (G). In this case, the casing (G), first of all, has a transparent cover (H), through which the sunbeams can reach the strings (A) of the top layer. Furthermore, the casing has to have dimensional characteristics such to be able to accommodate, besides the two layers of the installation, also all the components of the single axis solar tracking systems.

The photovoltaic installation, conceived according to the present detailed description, has the main (but not the sole) advantage of resulting to be completely manufactured protected from adverse and disturbing atmospheric agents, such as: wind, rain, hail, UV rays, etc. . . . And this certainly makes it much more reliable and safer with respect to similar installations manufactured in “open field”.

By giving particular constructive and dimensional characteristics to the casing (G), the photovoltaic installation according to the present invention can achieve a further advantage, which is that to be able to be (partially or totally) integrated in any building manufacturing product (a building or an agricultural greenhouse or a shed or a canopy roof, etc. . . . ) or, even, in any means for transporting people and/or goods (such as for example a camper or a boat).

Furthermore, the photovoltaic installation, manufactured according to this procedure, can also be manufactured in its totality, by assembling several casings together (G), up to achieving the dimensional and structural characteristics necessary for the case.

With regard to what set forth up to here, it is evident that the photovoltaic installation according to the present invention proposes the maximization of the profitable exploitation of the sunlight incident on a fixed terrestrial surface to be occupied, by means of the basic idea to manufacture it by utilizing two layers which are superimposed, distinct and separated. The top layer, manufactured with bifacial photovoltaic strings equipped with a single axis solar tracking system having “parallel” control, converts into electric energy only the diffused and reflected sunlight and lets the sunlight not already absorbed pass, towards the bottom layer. The bottom layer, if manufactured with photovoltaic strings, converts the sunlight coming from the top layer into further electric energy and, simultaneously, reflects the part which it does not manage to absorb towards the top layer. As a function of the constitutive and functional characteristics of the photovoltaic strings of the bottom layer, when necessary, an aliquot of the sunlight coming from the top layer can also pass through the bottom layer and direct, in a controllable manner, towards the ground below the installation. When the bottom layer, instead of being manufactured with additional photovoltaic strings, is manufactured with simple reflecting (also not flat) surfaces, the sunlight coming from the top layer is totally reflected towards the same, so as to increase the conversion capacities thereof into electric energy. If the bottom layer is equipped with a single axis solar tracking system, also in this case, the possibility remains to let an (a controllable) aliquot of the natural light incident on the photovoltaic installation pass beyond the bottom layer and towards the environment below.

The usefulness of the photovoltaic installation according to the present invention can be better clarified also with some applicative examples.

Should one have at disposal an agricultural ground usefully exposed to the sun, the photovoltaic installation according to the present invention could allow converting into electric energy only part of the sunlight incident on it, letting an aliquot pass towards the ground to be cultivated, said aliquot being controllable based on the needs of the crops grown. In particular, the top layer (manufactured with bifacial photovoltaic strings with “parallel” single axis solar tracking) could limit to convert into electric energy only the diffused and reflected sunlight, letting the incident sunlight pass, almost entirely, towards the bottom layer. The bottom layer (manufactured with single axis solar tracking bifacial photovoltaic strings, additional, distinct and independent of those of the top layer) could intercept the sunlight coming from the top layer for converting only an (a controllable) aliquot into additional electric energy, voluntarily letting the remaining part pass towards the ground below, all as a function of the natural light requirements of the crops grown. In this manner, a generation of electric energy of all respect (thanks to the generation of the “double layer”) and the optimal control of the natural light requirements of the crops grown would be simultaneously obtained. On the other hand, if wanting to only maximize the conversion of the sunlight incident on a given terrestrial surface into electric energy, the double-layer photovoltaic installation, according to the present invention, can be utilized for producing a multiple conversion of the sunlight into electric energy, without letting any aliquot of incident sunlight pass under it. In this case, in fact, the incident sunlight would first be made to pass through the top layer of photovoltaic strings which, by implementing the “parallel” solar tracking, would convert into electric energy only the diffused and reflected components, letting the incident sunlight pass beyond almost entirely. Said incident sunlight could direct towards the bottom layer of additional photovoltaic strings, which, capturing it instead according to the prior art (for example, in a manner almost perpendicular), would convert it in an optimal manner into additional electric energy. Furthermore, the aliquot of sunlight incident on the photovoltaic strings of the bottom layer, not absorbed and not already converted into electric energy, would anyway be reflected towards the strings of the top layer which would further increase the quantity of overall electric energy generated by the double-layer installation. According to this principle, the clear objective that the photovoltaic installation according to the present invention proposes to achieve is that to obtain, the terrestrial surface exposed to the sun and occupied being equal, a much larger production of electric energy than that to date guaranteed by the photovoltaic installations of the prior art. If, once fixed the terrestrial surface available for the manufacturing of the photovoltaic installation, a comparison were made with the expected daily production for a conventional installation equipped with single axis solar tracker, with a single layer and a perpendicular tracking, the expectations, for an optimal double-layer photovoltaic installation, allow providing for a daily production greater than approximately 60-80%.

In order to better appreciate the constitutive details and the operation of the double-layer photovoltaic installation according to the present invention, also various drawings and some photo-realistic representations have been provided, shown in specially provided figures which are indicated and discussed in the following.

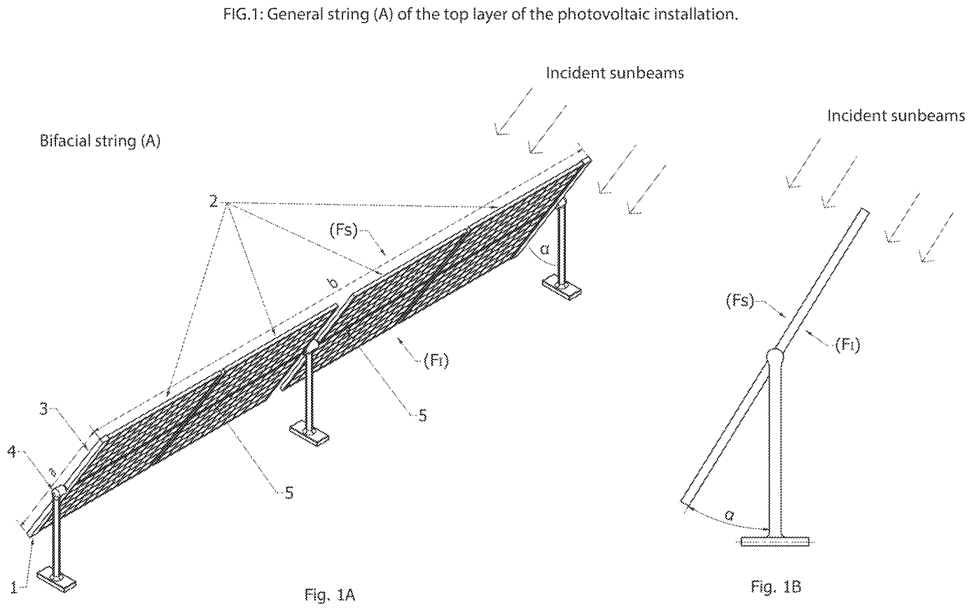

FIG. 1 illustrates the constitutive characteristics of one single and general bifacial photovoltaic string (A), which is the founding and indispensable element of the top layer of the photovoltaic installation according to the present invention. In the figure, its transversal edges (1) are highlighted, which have width (a), as well as its longitudinal edges (2), which have width (b). The so-called “terminations” (3) are also represented, mounted on its two transversal edges (1). On the terminations (3), also the relative longitudinal pins (4) are represented with which they are equipped. The latter, once the terminations are mounted on the transversal edges of the strings (A), will result to be aligned with one another, making, in actual fact, the longitudinal rotation axis (5) of the string (A). The figure clearly illustrates how the string (A) is oriented, by the single axis solar tracking system, so that the incident sunbeams result to be parallel to its top face (F_{S}) and bottom face (F_{I}).

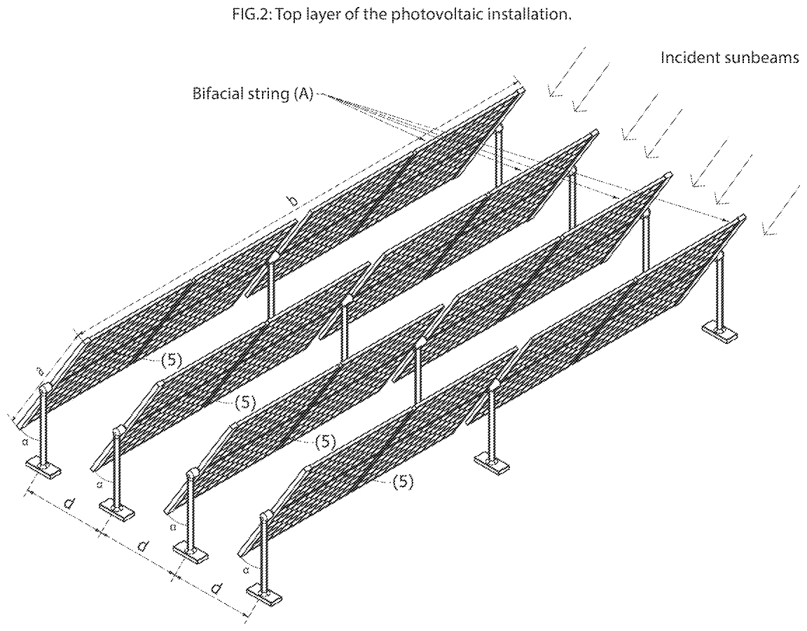

FIG. 2 illustrates the constitution of the top layer of the photovoltaic installation according to the present invention when the strings (A) are installed in side-by-side parallel rows. In particular, it is shown how, in such case, the strings (A) are installed at a distance (d) between their rotation axes (5). Such distance (d) can be optimized as a function of the installation direction of the rotation axes (5), keeping into account that, theoretically, it can vary from zero (when the rotation axes are installed along the east-west direction) to the maximum value equal to the width (a) of one single string (A) (when the rotation axes are installed along the north-south direction). It remains obvious that, once fixed the installation direction of the rotation axes (5) of the strings (A), the maximum number of side-by-side strings (A) which can be installed per unit of terrestrial surface remains fixed, without them mutually shadowing one another, during their daily rotations.

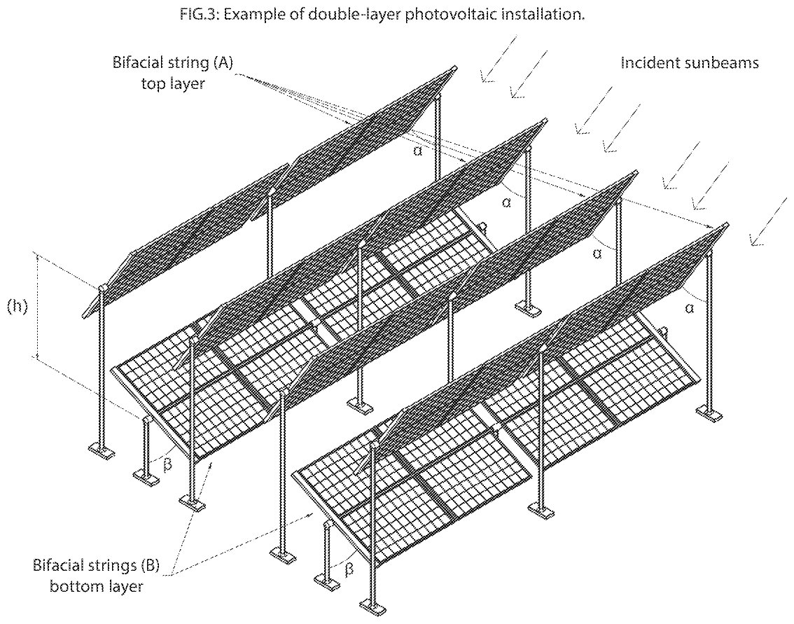

FIG. 3 illustrates the double-layer installation when, in order to increase the generation of electric energy while still maintaining a certain degree of transparency of the overall installation to the incident sunlight, additional photovoltaic strings (B) are mounted under the strings (A) of the top layer, said additional photovoltaic strings (B) also being of bifacial type and equipped with a single axis solar tracking system. In the figure it is shown how the strings (B) are distinct from and independent of the strings (A), also comprising the relative solar tracking systems. The figure also illustrates how the number of the strings (B) can be different from the number of the strings (A). Although not shown in figure, it is here reminded that the strings (B) can be installed with the relative rotation axes arranged along directions also different from those of the rotation axes of the strings (A). The strings (B) can further be oriented (by their solar tracking system) also according to control logics different from those used for the strings (A), for example and according to the prior art, also perpendicular to the incident sunbeams. In order to guarantee the full independence between the various solar tracking systems, as specified above, the figure also reminds that the strings (B) have to be mounted under the strings (A) at a distance (h) between the planes that contain the rotation axes of the strings (A) and of the strings (B) which has to be large enough to guarantee the free rotation of the strings (A) and (B) by an angle which, when necessary, can also reach 180°.

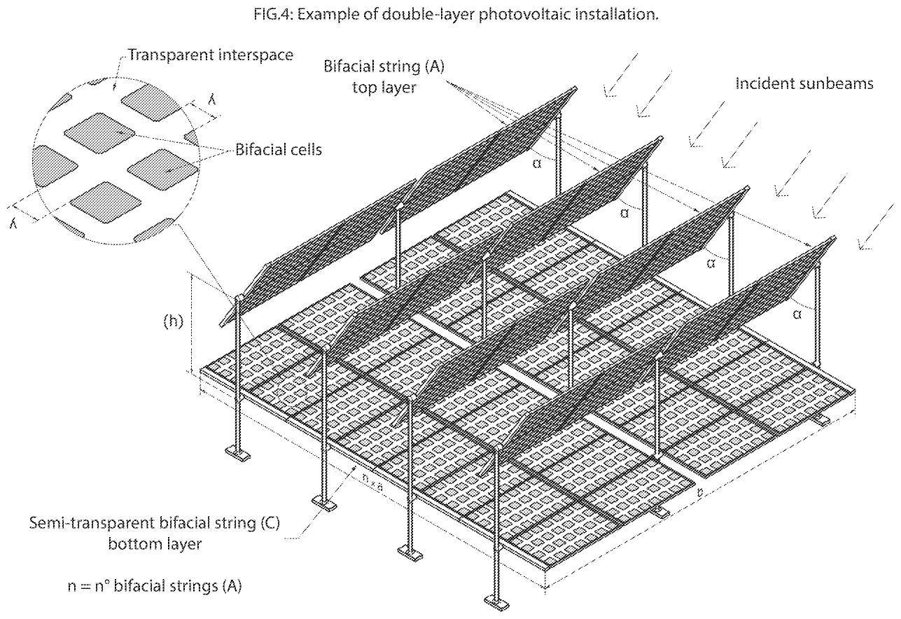

FIG. 4 illustrates the double-layer installation in which, in order to increase the generation of electric energy while still maintaining a certain degree of transparency of the overall installation to the incident sunlight, an additional photovoltaic string (C) is mounted under the strings (A) of the top layer, said additional photovoltaic string (C) also being of bifacial type but semi-transparent to the sunlight and without a single axis solar tracking system (therefore, fixed). The photovoltaic cells forming the string (C) are, in fact, inter-distanced between one another by a quantity (□), such to guarantee the string (C) with a certain degree of semi-transparency to the sunlight, which can be optimized in designing step, according to the case. In the figure it is shown how the string (C) is single but its ground footprint surface is the same of the maximum one of the entire top layer formed by (n) strings (A). Finally, in order to guarantee the full functionality and independence of the single axis solar tracking system with which the strings (A) are equipped, the figure also reminds that the string (C) has to be mounted under the strings (A) at a distance (h), from the plane which contains the rotation axes of the strings (A), large enough not to prejudice the necessary rotation of the latter.

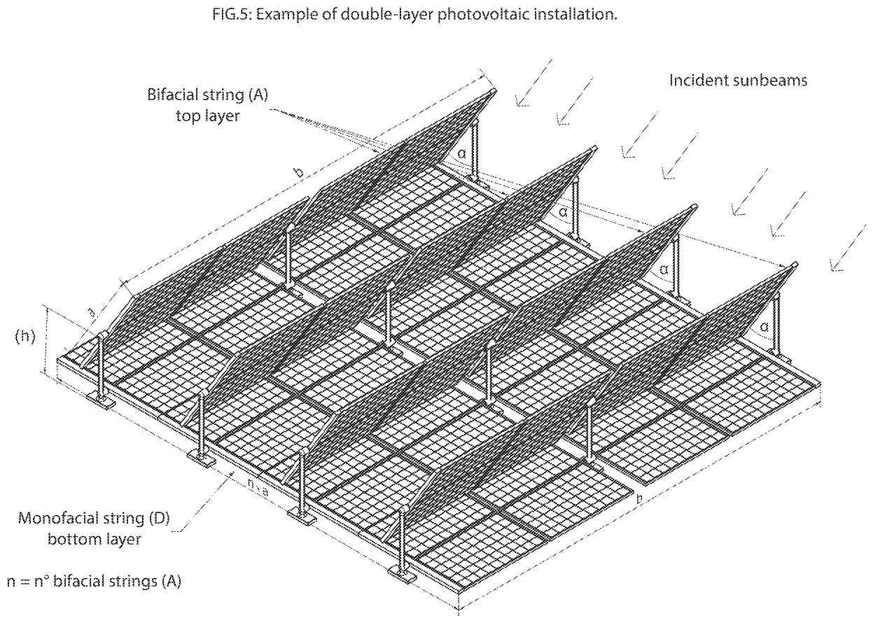

FIG. 5 illustrates the double-layer installation in which, in order to further increase the generation of electric energy, renouncing the transparency of the overall installation to the incident sunlight, an additional photovoltaic string (D) is mounted under the strings (A) of the top layer, said additional photovoltaic string (D) being of monofacial (opaque) type and without a single axis solar tracking system (therefore, fixed). In the figure it is shown how the string (D) is single but its ground footprint surface is the same of the maximum one of the entire top layer formed by (n) strings (A). Finally, in order to guarantee the full functionality and independence of the single axis solar tracking system with which the strings (A) are equipped, the figure also reminds that the string (D) has to be mounted under the strings (A) at a distance (h), from the plane which contains the rotation axes of the strings (A), large enough not to prejudice the necessary rotation of the latter.

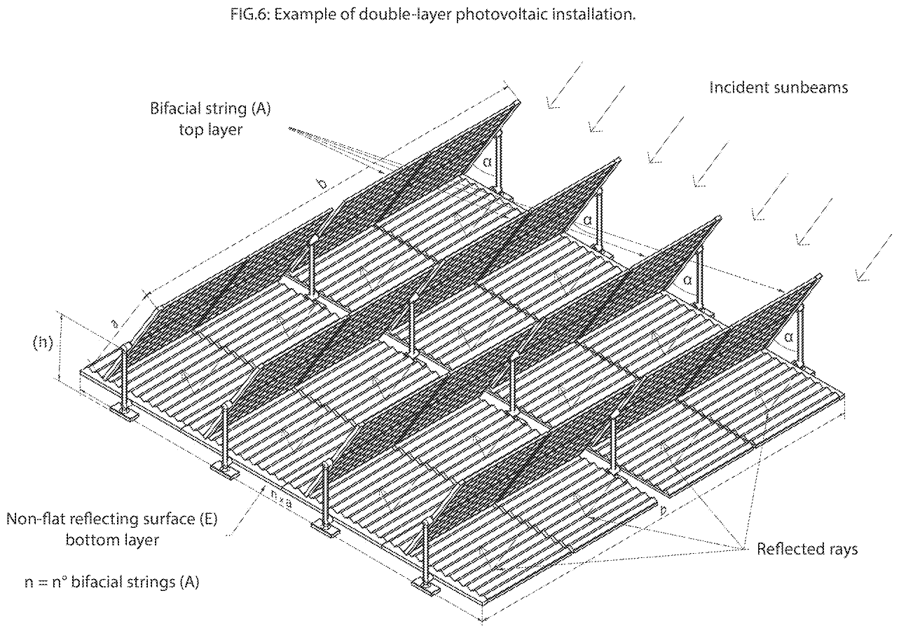

FIG. 6 illustrates the double-layer installation in which, in order to decrease the costs and the complexity of the installation, without renouncing the objective of increasing the generation of electric energy per unit of utilized terrestrial surface and renouncing, instead, the transparency of the overall installation to the incident sunlight, an additional reflecting surface (E) is mounted under the strings (A) of the top layer, said additional reflecting surface (E) having a geometry also not flat. In the figure it is shown how the reflecting surface (E) is single but, regardless of its geometry (possibly not flat), its ground footprint surface is the same of the maximum one of the entire top layer formed by (n) strings (A). Finally, in order to guarantee the full functionality and independence of the single axis solar tracking system with which the strings (A) are equipped, the figure also reminds that the reflecting surface (E) has to be mounted under the strings (A) at a distance (h), from the plane that contains the rotation axes of the strings (A), large enough not to prejudice the necessary rotation of the latter. The choice of the geometry and of the constitutive materials of the reflecting surface (E), which in actual fact makes the bottom layer of the installation, can significantly influence the increase in the generation of electric energy by the bifacial photovoltaic strings (A) of the top layer; therefore, these aspects can be object of study and experimentations in order to identify the most profitable solutions.

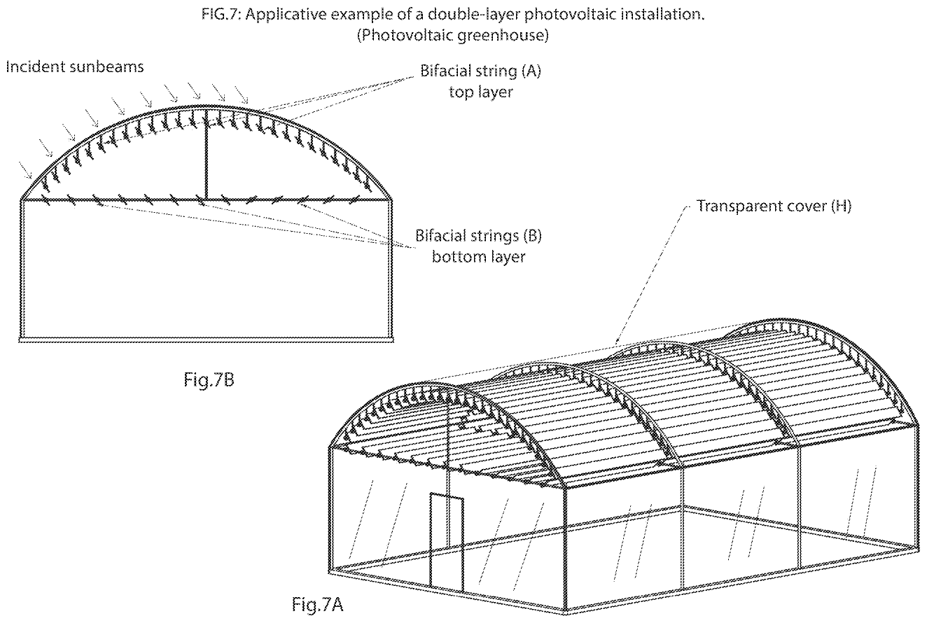

FIG. 7 illustrates a first applicative example and expressly refers to the case of a typical agricultural greenhouse equipped with a photovoltaic generator. Unlike the prior art, the photovoltaic generator is manufactured according to the present invention.

In fact, the photovoltaic installation is, first of all, entirely manufactured inside a transparent casing (G)—in actual fact, the same agricultural greenhouse—which protects it from adverse atmospheric agents. Secondly, the installation clearly shows two layers of photovoltaic strings. The top layer is manufactured with bifacial photovoltaic strings (A) equipped with a single axis solar tracking system. The aforementioned strings (A) are constructed based on “special” bifacial photovoltaic modules (constructed ad hoc), which have the shape of “elongated strips” (narrow and long) and the relative cells are incapsulated between two layers of specially provided highly transparent plastic materials (instead of glass) and do not have containment and strengthening metallic frames. In such manner, the aforementioned modules, and the consequent strings (A), result to be, simultaneously, light and cost-effective. That said, the strings (A) are installed in parallel rows which follow the geometry of the transparent cover of the greenhouse and are installed at a distance (d) between one another such that—when necessary—they can also make the transparent cover of the greenhouse totally “opaque”. The bottom layer of the installation is manufactured with bifacial photovoltaic strings (B), these too equipped with a single axis solar tracking system. The strings (B) are distinct from and independent of the strings (A), as are the relative single axis solar tracking systems. Furthermore, the strings (B) are in smaller number than that of the strings (A). The strings (B) are in charge of intercepting the sunlight let to pass from the upper strings (A) for converting it, in a controlled manner and depending on the energy and natural light requirements of the greenhouse and of the crops grown, all or in part into additional electric energy. In this manner, it is possible to optimize the overall generation of electric energy of the photovoltaic installation, by incorporating in it—according to the case—the specific natural light requirements of the crops grown.

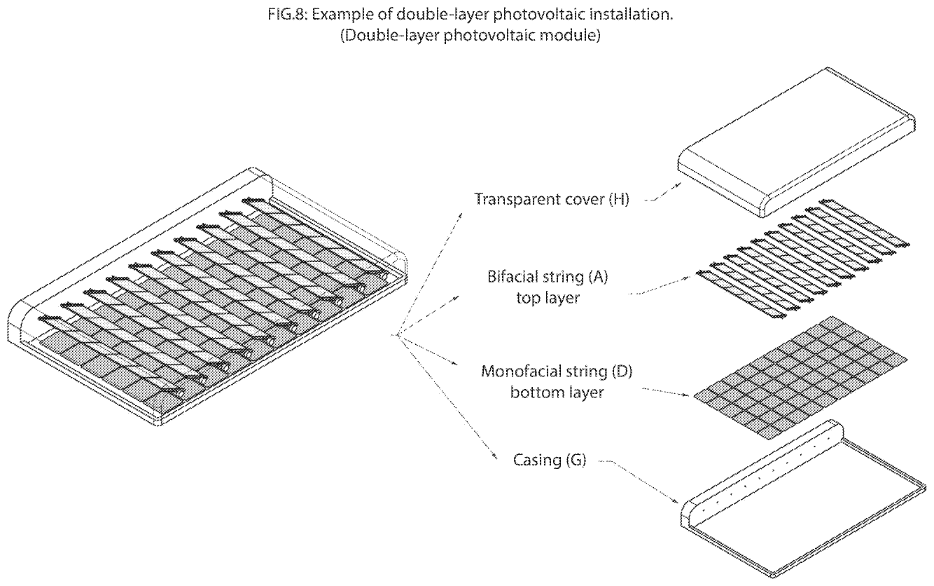

FIG. 8 illustrates a second applicative example and expressly refers to the case where the double-layer photovoltaic installation can be manufactured inside a transparent and protective casing (G), which can also be integrated in a building/manufacturing product, and the installation is exclusively aimed at the maximization of the electric energy which can be generated starting from the surface effectively exposed to the sunlight and available for its installation. In this case, the double-layer photovoltaic installation translates in actual fact in a double-layer photovoltaic module. In this case, the casing (G) has the shape of a conventional module but, obviously, is characterized by a greater thickness. It is equipped with a specially provided transparent cover (H), which can be made of different materials, among which glass or polycarbonate or still others. Also in this case, the photovoltaic strings (A) of the top layer are bifacial and are equipped with a single axis solar tracking system, with parallel tracking. As in the previous case, they are manufactured starting from special bifacial photovoltaic modules (constructed ad hoc), which have the shape of elongated strips, even more narrow than the previous ones. Even this time, the cells of the aforementioned bifacial modules are incapsulated between two layers of highly transparent and light plastic material (instead of glass) and are not equipped with containment and strengthening metallic frames. Still once again, the strings (A) are installed in side-by-side parallel rows, in a number which can be maximized as a function of the installation direction of the relative rotation axes (given by the characteristics of exposure to the sun of the useful available surface) in order to maximize the electric energy which can be produced, intercepting the diffused sunlight as well as the reflected one from the bottom layer. The bottom layer of the installation is manufactured, instead, with one single opaque monofacial photovoltaic string which entirely occupies the area below the strings (A) of the top layer. In this manner, it is possible to maximize the overall generation of electric energy of the photovoltaic installation, starting from the sunlight which passes through the top layer, with the expectation, already in part experimented, of managing to increase it, with respect to that generated by a fixed and single-layer monofacial conventional module (which occupies the same surface), by a percentage of approximately 60-80%.

Summarizing, based on all that has been set forth above, it is clear that the present invention proposes the manufacturing of a double-layer photovoltaic installation, equipped with at least one single axis solar tracking system controlled according to a new logic of “parallel tracking” and that, with respect to the photovoltaic installations of the prior art, promises to be able to significantly increase the conversion into electric energy of the sunlight incident on a predetermined terrestrial surface. If considered suitable and convenient, the double-layer photovoltaic installation according to the present invention can be utilized also for incorporating two different objectives: that of the maximization of the electric energy which can be generated, on the one hand, and that of the direct and controlled (and, therefore, profitable) exploitation of sunlight as such, on the other hand.

1. A double-layer photovoltaic installation, comprising a top layer and a bottom layer, wherein:
the top layer of the installation consists of a plurality of bifacial photovoltaic strings arranged parallel to one another and each of which has a top surface and a bottom surface, both capable of generating electric energy from the sun;
a single axis solar tracking system is connected to the photovoltaic strings, the former being adapted to rotate the latter by an angle around their rotation axes;
the solar tracking system orients the photovoltaic strings arranging said top surface and said bottom surface, of each photovoltaic string, in a position parallel to the incident sunbeams, so that only a minimum shadow is projected on the bottom layer of the installation;
the bottom layer of the installation consists of further photovoltaic strings.

2. The double-layer photovoltaic installation according to claim 1, wherein the bottom layer of the installation consists of photovoltaic strings, which:
have the same constructive characteristics of the strings, as claimed in claim 1, but can also be different in number;
are equipped with a single axis solar tracking system which is distinct from and independent of the one of the strings so as to allow the strings to perform an angular rotation, around relative axes, with amplitude;
are mounted under the strings and in such a way not to prejudice the rotation independence thereof specified in claim 1.

3. The double-layer photovoltaic installation according to claim 1, wherein the bottom layer of the installation consists of bifacial and semi-transparent photovoltaic strings, without solar tracking system, in which the strings are mounted under the strings and in such a way not to prejudice the rotation independence thereof specified in claim 1.

4. The double-layer photovoltaic installation according to claim 1, wherein the bottom layer of the installation consists of monofacial and opaque photovoltaic strings, without solar tracking system, in which the monofacial photovoltaic strings are mounted under the strings and in such a way not to prejudice the rotation independence thereof specified in claim 1.

5. (canceled)

6. The double-layer photovoltaic installation according to claim 1 further comprising a casing arranged to contain the two layers, top and bottom, of said photovoltaic installation; said casing comprising a transparent cover resistant against atmospheric agents and having constructive characteristics such that it can also be partially or totally integrated in any building manufacturing product and/or transport means.

7. The double-layer photovoltaic installation according to claim 1, wherein the rotation axes of the photovoltaic strings of the top layer are coplanar with respect to one another.

8. A method for producing electric energy from a double-layer photovoltaic installation comprising a top layer and a bottom layer, wherein:
the top layer of the installation consists of a plurality of bifacial photovoltaic strings arranged parallel to one another and each of which has a top surface and a bottom surface, both capable of generating electric energy from the sun;
a single axis solar tracking system is connected to the photovoltaic strings, the former being adapted to rotate the latter by an angle around relative rotation axes;
the bottom layer of the installation consists of further photovoltaic strings; and
solar tracking operation adapted to orient the photovoltaic strings so that the relative surfaces and result to be in a position parallel to the incident sunbeams.

9. The method according to claim 8, further comprising a screening operation to the variable sunlight, in which said further photovoltaic strings are rotated, in an independent manner with respect to the photovoltaic strings of the top layer, so as to control both the entity of the sunlight intercepted and screened by them and the entity of the sunlight that passes through the photovoltaic installation in its whole.
